(19) United States
(12) Patent Application Publication
(10) Pub. No.: US 2026/0149246 A1
(43) Pub. Date: May 28, 2026

(54) PIN-HINGE CABLE AND CONNECTOR CLIP

(71) Applicant: Molex, LLC, Lisle, IL (US)

(72) Inventors: Christopher Richard Pinkham Basa, St. Paul, MN (US); Wenzong Chen, Naperville, IL (US); Trevor Dean Smith, Eden Prairie, MN (US)

(21) Appl. No.: 19/363,838

(22) Filed: Oct. 21, 2025

Related U.S. Application Data
(60) Provisional application No. 63/726,212, filed on Nov. 27, 2024.

(51) Int. Cl. H02G 3/04

(52) U.S. Cl. CPC H02G 3/045; H02G 3/0418

(57) ABSTRACT

A cable clip for organizing and adding integrity to cables includes a base plate and a handle rotatably coupled to the base plate. The base plate defines one or more cable storage areas, and includes a handle support portion having a shoulder, at least one handle engagement projection extending upwards from the shoulder, and an aperture positioned within the at least one handle engagement projection. The handle includes a bottom surface having a projection configured to extend into the aperture and an annular travel path defined therein adapted to receive the at least one handle engagement portion and provide a path of travel for the handle engagement projections during rotation of the handle. The plurality of cable storage areas can be sized and positioned to receive cable boots, for example, or other portions of cable assemblies.

### TECHNICAL FIELD

The present disclosure relates to cable management devices and systems and, more specifically, to clips and organizers for securing and arranging connectors, cable boots, wires, and like devices.

### BACKGROUND

Cable management is an important aspect of many industries, including telecommunications, data centers, and audio/visual installations. As the complexity and density of cabling systems increase, there is a growing need for efficient and organized cable routing solutions. Traditional methods of cable management often involve loose bundling or ad-hoc arrangements, which can lead to tangled wires, difficulty in tracing connections, and potential damage to cables or connectors.

Effective cable organization not only improves the aesthetic appearance of installations but also enhances functionality, accessibility, and maintenance. However, existing cable management devices may lack versatility in accommodating different cable sizes and types, fail to provide secure retention of cables, or prove cumbersome to use in tight spaces. Additionally, many cable organizers do not adequately protect sensitive cable components, such as boots or connectors, from strain or physical damage during installation and use.

### BRIEF SUMMARY

According to an aspect of the present disclosure, a cable clip for organizing cables is provided. The cable clip includes a base plate that has at least one divider defining a plurality of cable storage areas. The base plate further comprises a handle support portion having a shoulder, a handle engagement projection extending upwards from the shoulder, and an aperture positioned within the handle engagement projection. The cable clip also includes a handle rotatably coupled to the base plate. The handle comprises a bottom surface having a handle projection configured to extend into the aperture. The handle is sized and positioned to have an annular travel path in the bottom surface adapted to receive the handle engagement projection and provide a path of travel for the handle engagement projection during rotation of the handle. The plurality of cable storage areas are sized and positioned to receive a plurality of cable boots of a plurality of cables.

Each of the plurality of cable storage areas can include at least one surface contoured to conform to a geometry of the plurality of cable boots. The cable clip can further include a spring-loaded pin that biases the handle relative to the base plate, the spring-loaded pin extending through the handle projection and into the aperture of the base plate. The base plate can include a first end and a second end, the shoulder being positioned on the first end, and the handle can include a first end and a second end, the first end of the handle being rotatably coupled to the shoulder of the base plate via the spring-loaded pin.

The base plate can include a first end wall and a second end wall, the at least one divider being positioned between the first end wall and the second end wall. The base plate can include a front lip positioned between the first end wall and the second end wall, the front lip can include a degree of incline, and the at least one divider may extend to the front lip.

The handle can further include a contoured projection on a lower surface of the second end of the handle, the contoured projection comprising a hook, and the second end wall of the base plate can include a projection configured to align with the hook and fix the second end of the handle with the second end wall of the base plate. The handle can further include a release tab extending from the second end of the handle, wherein an upward force imposed on the release tab or the second end of the handle disengages the second end of the handle from the second end of the base plate. The annular travel path may be recessed into a bottom surface of the handle.

According to another aspect of the present disclosure, a pin-hinge clip for organizing cables is provided. The pin-hinge clip includes a base plate. The base plate comprises a plurality of dividers extending upwards from a bottom surface defining a plurality of cable storage areas. The pin-hinge clip also includes a handle rotatably coupled to the base plate about a spring-loaded pin that biases the handle relative to the base plate. The plurality of cable storage areas are sized and positioned to receive individual ones of a plurality of cable portions of a plurality of cables.

The plurality of cable portions may be a plurality of cable boots, and each of the plurality of cable storage areas can include at least one surface contoured to conform to a geometry of the plurality of cable boots. The base plate can include a handle support portion having a shoulder, at least one handle engagement projection extending upwards from the shoulder, and an aperture positioned within the at least one handle engagement projection, and the handle can include a bottom surface having a handle projection configured to extend into the aperture and a recess defined therein adapted to receive the at least one handle engagement projection, the recess defining an annular path of travel for the at least one handle engagement projection during a rotation of the handle.

The spring-loaded pin may extend through the handle projection and into the aperture of the base plate. The base plate can include a first end wall and a second end wall, the plurality of dividers being positioned between the first end wall and the second end wall. The base plate can include a front lip positioned between the first end wall and the second end wall, and the plurality of dividers may extend to the front lip.

The base plate can include a first end and a second end, the shoulder being positioned on the first end, and the handle can include a first end and a second end, the first end of the handle being rotatably coupled to the shoulder of the base plate. The handle projection can include a first tier and a second tier integral with one another, the second tier having a diameter less than the first tier, the second tier of the projection comprising a linear projection extending therefrom configured to be positioned in a corresponding slot in the shoulder of the base plate. The spring-loaded pin may extend through an aperture within the projection, and into a recess of the shoulder of the base plate.

The handle can further include a contoured projection on a lower surface of the second end of the handle, the contoured projection comprising a hook, and the second end of the base plate can include a projection configured to align with the hook and fix the second end of the handle with the second end of the base plate. The handle can further include a release tab extending from the second end of the handle, wherein an upward force imposed on the release tab or the second end of the handle disengages the second end of the handle from the second end of the base plate.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a front perspective view of a cable clip in a first state according to various embodiments of the disclosure.

FIG. 2 is another front perspective view of the cable clip according to various embodiments of the disclosure.

FIG. 3 is a rear perspective view of the cable clip according to various embodiments of the disclosure.

FIG. 4 is another rear perspective view of the cable clip according to various embodiments of the disclosure.

FIGS. 5 and 6 are perspective views of a base plate of the cable clip according to various embodiments of the disclosure.

FIG. 7 is an enlarged view of a callout region 7 of FIG. 6 according to various embodiments of the disclosure.

FIG. 8 is a top perspective view of the cable clip in a second state according to various embodiments of the disclosure.

FIG. 9 is a bottom perspective view of the cable clip according to various embodiments of the disclosure.

FIG. 10 is a top perspective view of the handle of the cable clip according to various embodiments of the disclosure.

FIG. 11 is a bottom perspective view of the handle of the cable clip according to various embodiments of the disclosure.

FIG. 12A is an enlarged bottom perspective view of the handle of the cable clip according to various embodiments of the disclosure.

FIG. 12B is a lower view of an end of the handle of the cable clip according to various embodiments of the disclosure.

FIG. 12C is an upper view of a shoulder of the base plate of the cable clip according to various embodiments of the disclosure.

FIGS. 13 and 14 show enlarged perspective views of a rotation of the handle of the cable clip according to various embodiments of the disclosure.

FIGS. 15 and 16 show perspective views of the cable clip in a closed state storing cable boots therein according to various embodiments of the disclosure.

FIGS. 17 and 18 show perspective views of the cable clip in an open state storing cable boots therein according to various embodiments of the disclosure.

FIG. 19 shows a rear view of the cable clip in the open state storing cable boots therein according to various embodiments of the disclosure.

FIG. 20 shows a rear view of the cable clip in the closed state storing cable boots therein according to various embodiments of the disclosure.

FIG. 21 shows a cross-section view of a spring-loaded pin of the cable clip according to various embodiments of the disclosure.

FIG. 22 shows another front perspective view of the cable clip storing cable boots according to various embodiments of the disclosure.

FIG. 23 shows another front perspective view of the cable clip according to various embodiments of the disclosure.

### DETAILED DESCRIPTION

The present disclosure relates to cable management systems and devices. In various industries such as telecommunications, data centers, and audio/visual installations, the organization and protection of cables and connectors pose significant challenges. As cabling systems become increasingly complex and dense, it can be ideal to have efficient and secure cable routing solutions. Existing cable management methods, however, lead to tangled wires, difficulty in tracing connections, and damage to sensitive cable components.

Accordingly, various embodiments for a cable clip are disclosed for organizing and securing cables, connectors, or particular portions thereof. In various embodiments, the cable clip may include a base plate and a handle rotatably coupled to the base plate. The base plate can include one or more dividers that define one or more cable storage areas for storage of cable portions. Alternatively, the base plate can include ends that define a cable storage area for storage of the cable portions, where no dividers are provided. The cable portions can include, for example, cable boots or, in other words, protective covering for cables and connectors that shield the cables from damage caused by bending, strain, or environmental factors. In other embodiments, however, the cable portions can include other parts of the cables, such as the wire portions, the connector housings, and so forth. The handle can provide controlled rotation using a biasing member and can provide secure closure of the cable portions within the cable storage areas.

The cable clip described herein can thus be configured to receive and organize individual cable boots or other cable portions. A cable boot is designed to prevent a cable at an end of a connector from bending sharply, which can cause signal loss. To ensure the connector and cable function correctly and meet industrial standards (e.g., GR-1435-Core), the cable clip can be removed once any connectors retained therein are mated. In some cases, the cable storage areas of the base plate are sized and positioned to accommodate specific cable components. The rotatable handle, working in conjunction with the base plate, can provide a mechanism for securing the cables within the clip.

The embodiments of the cable clip described herein can prevent tangling of cables, improve the traceability of connections, and provide protection for sensitive cable components such as cable boots or connector housings. In some aspects, the cable clip can act as a stiffener, preventing bending or manipulation of cables at sensitive locations. The cable clip can permit easy installation and removal of cables, while maintaining a secure hold during use. Additionally, the compact nature of the clip can make it suitable for use in space-constrained environments.

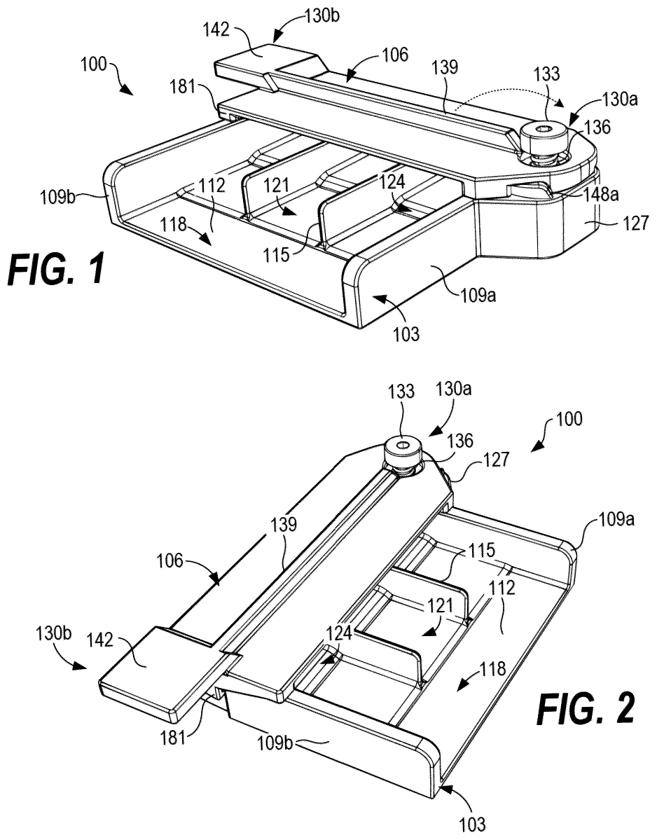

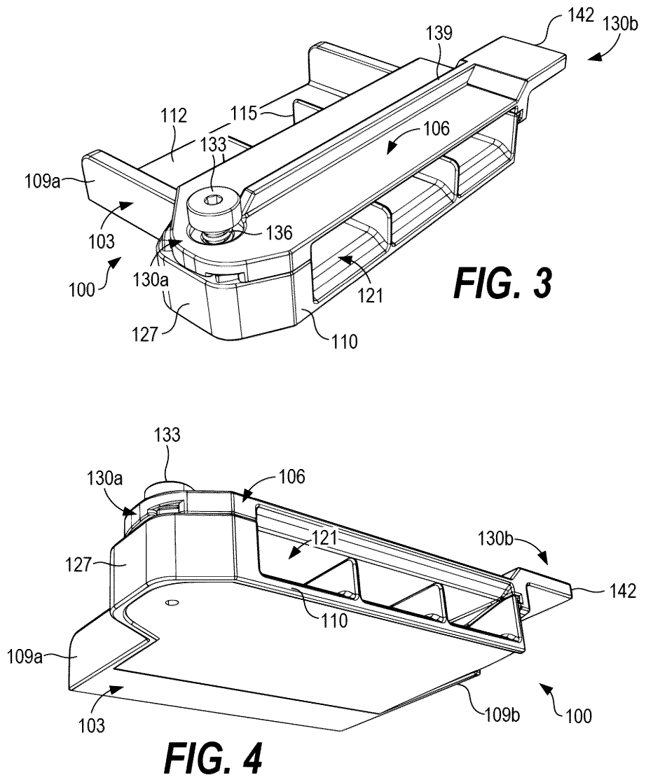

Turning now to the drawings, FIGS. 1 and 2 show front perspective views of a cable clip 100 according to various embodiments. FIGS. 3 and 4 show rear perspective views of the cable clip 100. Referring to FIGS. 1-4 collectively, the cable clip 100 can include a base plate 103 and a handle 106 movably coupled to the base plate 103. In some embodiments, the handle 106 is rotatably coupled to the base plate 103. For instance, the handle 106 can pivot forward or backwards relative to the base plate 103, as will be described

The base plate 103 can be a generally rigid or sturdy structure in which one of more cable portions (not shown) can be disposed. The base plate 103 can include end walls 109a, 109b (collectively “end walls 109” or “base plate end walls 109”), a rear wall 110 coupling the end walls 109, and a front lip 112 positioned between the end walls 109.

The base plate 103 can include one or more dividers 115 which project upwards from a bottom surface 118 of the base plate 103. The dividers 115 define a multitude of cable storage areas 121 adapted to corresponding cable portions. The dividers 115 can include generally planar structures that extend vertically from the bottom surface 118 of the base plate 103. The cable storage areas 121 formed by the dividers 115 can be sized and positioned to accommodate specific cable components, such as cable boots or connector housings. While various embodiments show two dividers 115 that, together with the end walls 109 and the rear wall 110, provide two cable storage areas 121, the disclosure is not so limited, and the number of dividers 115 can be one, three, four, five, and so on. The dividers 115 and the cable storage areas 121, along with the front lip 112, can be positioned between the end walls 109 of the base plate 103, providing a contained area for organizing and securing the cable components. This configuration can help prevent cable portions or cables from slipping out of the sides of the cable clip 100, as can be appreciated.

The bottom surface 118 of the base plate 103 can be contoured or non-uniform in some embodiments. To this end, in some embodiments, the bottom surface 118 positioned within the cable storage areas 121 can be adapted to conform to cable boots or other desired cable portions of a cable or connector. In some examples, the bottom surface 118 can include a slope 124 or an inclined area positioned between two surfaces, where the slope 124 can prevent forward and/or rearward translation of the cable portion. Like the bottom surface 118 of the cable storage areas 121, the front lip 112 can slope downward towards a front distal end of the base plate 103 and the cable clip 100, which can prevent translation of the cable portion in forward or rearward directions.

The base plate 103 can further include one or more shoulders 127 positioned on sides of the base plate 103. For instance, the shoulder 127 can be positioned on one or both sides of the base plate 103 and can be raised relative to the bottom surface 118 of the base plate 103. In the embodiments shown, the shoulder 127 is positioned at a first end of the base plate 103 integral with the first end wall 109a, whereas no shoulder 127 is provided on the second end of the base plate 103.

The handle 106 can also include a first end 130a and a second end 130b. The first end 130a can be rotatably coupled to the first end of the base plate 103. For instance, the first end 130a can be rotatably coupled to the shoulder 127 of the base plate 103 or other suitable portion of the base plate 103, whereas the second end 130b of the handle 106 can be free and/or detachably attachable to the second end of the base plate 103, as will be described.

A geometry of the base plate 103 and a geometry of the handle 106 alone can facilitate a coupling of the base plate 103 and the handle 106. However, in some embodiments, a pin 133 can be positioned through the handle 106 and into the base plate 103 to further secure the handle 106 to the base plate 103. The handle 106 can pivot or rotate about the pin 133, as can be appreciated.

In some embodiments, the pin 133 is spring-loaded via a biasing member, where the biasing member can include a spring 136 according to various example embodiments. The spring 136 or other biasing member can bias the pin 133 and the handle 106 relative to the base plate 103, acting as a spring-loaded hinge, as can be appreciated. Thus, in some aspects, the pin 133 can be referred to as a spring-loaded pin. In some embodiments, the geometry of the handle 106 and the pin 133 permits a slight vertical movement of the handle 106 relative to the pin 133 or the shoulder 127, which can assist with disengaging the handle 106, as will be described. FIGS. 1-4 show the handle 106 in a closed state, where a second end 130b of the handle 106 is coupled to the second end wall 109b of the base plate 103. However, the second end 130b of the handle 106 can be disengaged from the base plate 103 or, more specifically, the second end wall 109b thereof.

In some embodiments, the spring 136 can be replaced or supplemented with other biasing elements to provide the desired rotational resistance and return force for the handle 106. For example, the cable clip 100 can include a torsion spring, where one end of the spring 136 can be anchored to the base plate 103 and the other end of the spring 136 connected to the handle 106. In other embodiments, an elastomeric element, such as a rubber or silicone insert, can be positioned between the handle 106 and the base plate 103 to provide a biasing force. For instance, the elastomeric element can be compressed when the handle 106 is rotated, storing potential energy that helps return the handle 106 to its original position.

In some embodiments, the cable clip 100 can include a leaf spring, which can be attached to either the handle 106 or the base plate 103 and contact the other component to provide resistance and return force. In some embodiments, the cable clip 100 can include a magnetic biasing system. For instance, the cable clip 100 can include magnets in both the handle 106 and the base plate 103, oriented to repel each other when the handle 106 is rotated. The magnetic force can provide both resistance to rotation and a return force to bring the handle 106 back to its original position. In various embodiments, a combination of any of the foregoing biasing elements can be employed in the cable clip 100 to achieve desired rotational characteristics for the handle 106. For example, a coil spring may be used in conjunction with an elastomeric element to provide both initial resistance and a soft stop at the end of the rotation range, and so forth.

The handle 106 can further include a cross-member 139 that projects upwards from a planar surface of the handle 106. The cross-member 139 can facilitate a gripping of the handle 106 by an operator, especially when the handle 106 in a closed state or position or in a difficult to access location. The handle 106 can further include a release tab 142. The release tab 142 can project upwards and laterally from the handle 106 and, in some embodiments, the release tab 142 can project beyond a perimeter of the second end wall 109b of the base plate 103. The release tab 142, being positioned on an opposite end of the handle 106 of the pin 133, can act as a lever providing leverage to easily disengage the handle 106 from the base plate 103.

In some aspects, the base plate 103 and/or the handle 106 can be manufactured from plastic or other polymer materials, which can offer lightweight construction, durability, and resistance to heat and corrosion. Additionally, plastic or polymer materials can offer flexibility in design, allowing for the creation of complex shapes and features that can enhance the functionality of the cable clip 100. The choice of material for the base plate 103 and/or the handle 106 can also contribute to the overall performance of the cable clip 100. For instance, certain polymers can provide good insulation properties, which can be beneficial in electrical applications. The material can also be selected to withstand various environmental conditions, such as temperature fluctuations or exposure to moisture, depending on the particular application of the cable clip 100.

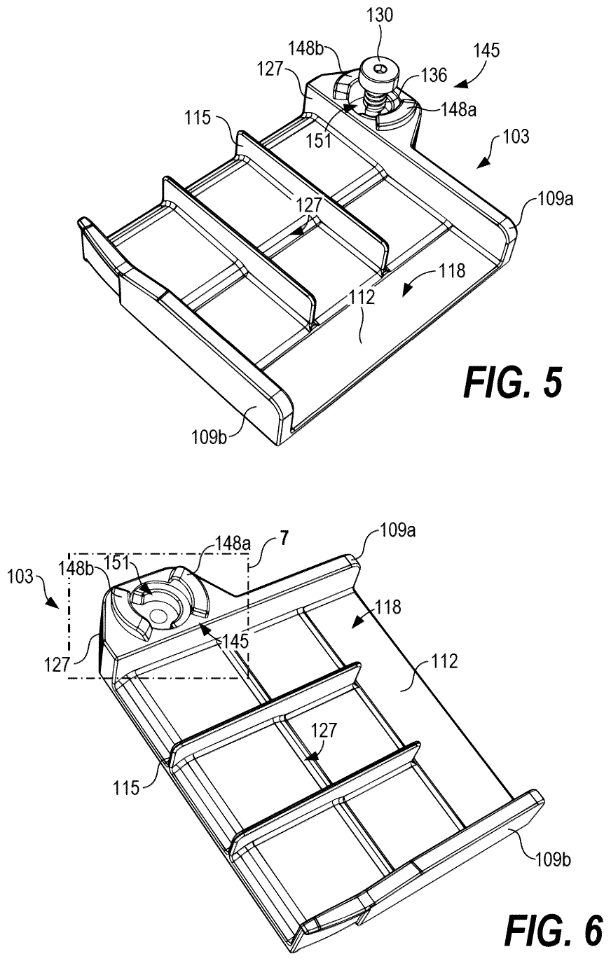

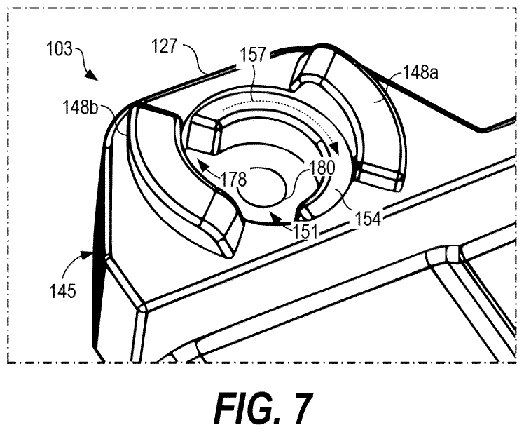

Moving along, FIG. 5 is a top perspective view of the base plate 103 with the handle 106 omitted for explanatory purposes. Similarly, FIG. 6 is a top perspective view of the base plate 103 with all other components of the cable clip 100 omitted for explanatory purposes. FIG. 6 features callout region 7. FIG. 7 is an enlarged view of the callout region 7 of FIG. 6.

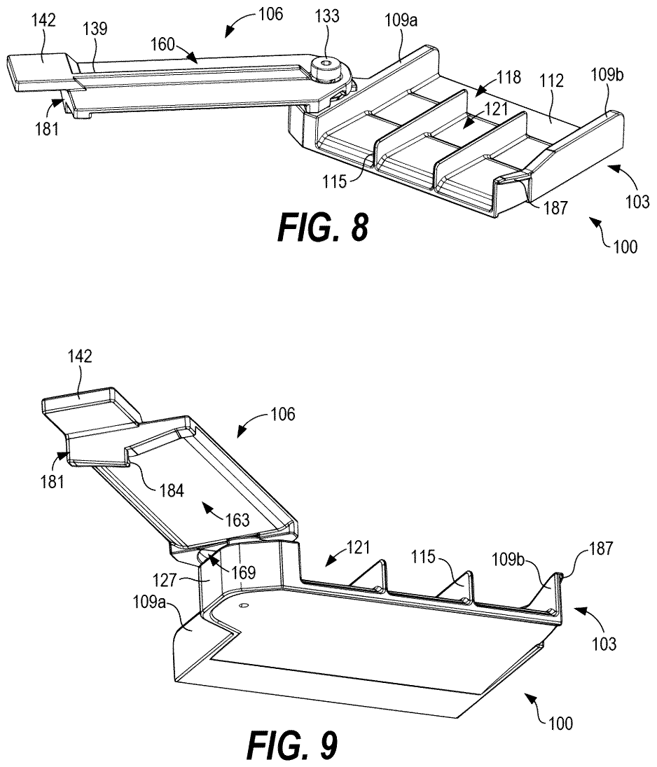

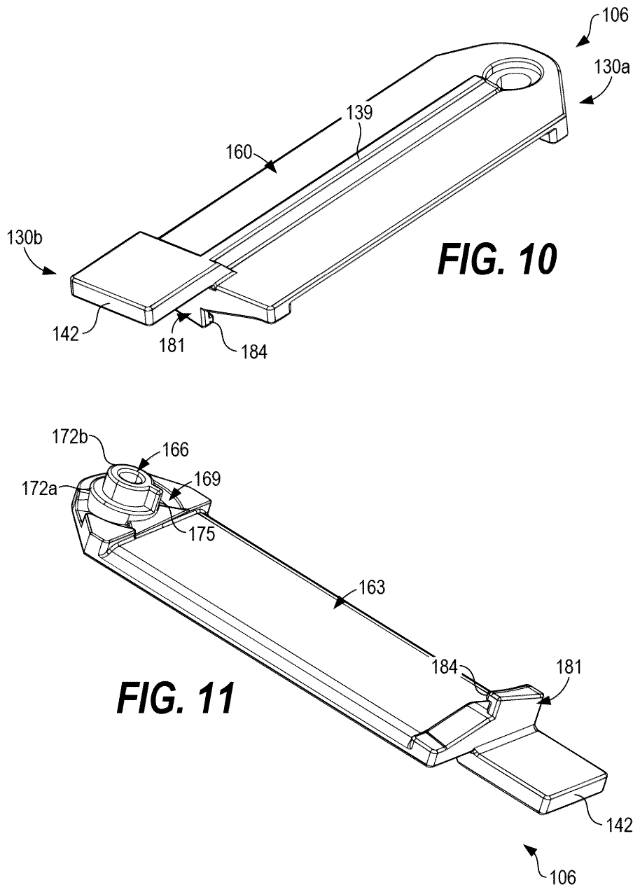

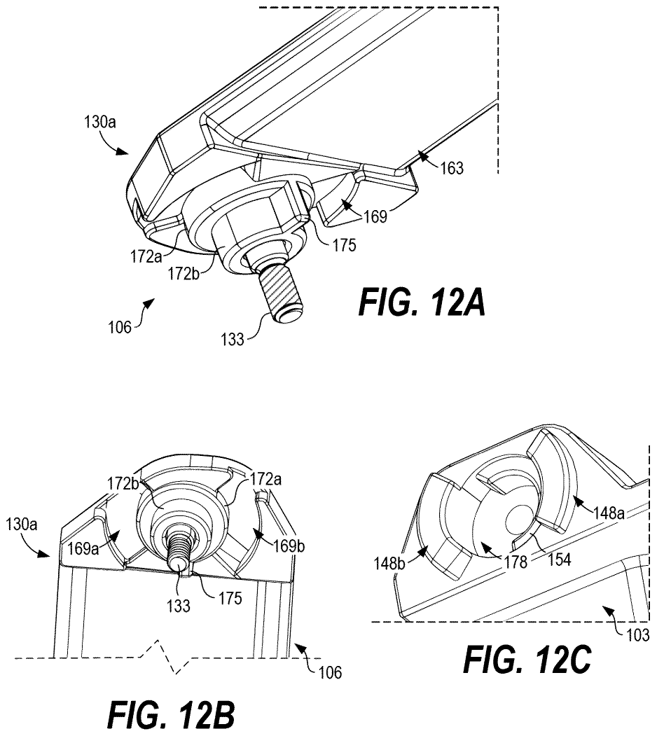

FIGS. 8 and 9 show perspective view of the cable clip 100 in an open state, where the handle 106 is disengaged from the base plate 103, and is rotated about the pin 130. FIGS. 10 and 11 show the handle 106 with the base plate 103 and other components of the cable clip 100 omitted for explanatory purposes. FIG. 12 is an enlarged bottom perspective view of the first end wall 109a of the handle 106.

Referring first to FIGS. 5-7, the base plate 103 can further include a handle support portion 145. The handle support portion 145 can support the handle 106 and, as such, the handle support portion 145 can include the shoulder 127 among other components. For instance, the handle support portion 145 can include one or more handle engagement projections 148a, 148b (collectively “handle engagement projections 148”) extending upwards from the shoulder 127 that can couple to the handle 106 to facilitate a connection between the handle 106 and the base plate 103.

In various embodiments, the handle support portion 145 can further include an aperture 151 where, in some embodiments, the aperture 151 is positioned within or between or in the center of the handle engagement projections 148. The handle engagement projections 148 can project from a top surface of the shoulder 127 of the base plate 103. The aperture 151 can have a ridge 154 nested or otherwise positioned therein. The aperture 151 and/or the ridge 154 can provide an annular travel path 157, permitting the handle 106 to rotate about the annular travel path 157.

Referring to FIGS. 8-12, the handle 106 includes an upper surface 160 and a lower surface 163. The lower surface 163 can be configured to correspond to a contoured surface of a cable boot or other cable portion (not shown) to be stored in the storage areas 121. Thus, the lower surface 163 can grip or otherwise provide surface contact between the handle 106 and the cable portions stored in the storage areas 121. In some embodiments, the lower surface 163 can provide a predetermined amount of clearance between the lower surface 163 and the contoured surface of the cable portion stored in the storage areas 121 that can permit slight translation of the cable portions relative to the cable clip 100 (e.g., forwards or backwards). In some embodiments, the clearance is 5 mm, although other suitable dimensions can be employed, such as 3 mm, 6 mm, 7 mm, and so forth.

The lower surface 163 of the handle 106 can include a handle projection 166. The handle projection 166 can have a shape that conforms to the aperture 151, such that the handle projection 166 can extend into the aperture 151 of the base plate 103. For instance, the handle projection 166 can be annular or other suitable shape that facilitates rotation of the handle 106 relative to the base plate 103. Moreover, the lower surface 163 of the handle 106 can include a recess 169 corresponding to the one or more handle engagement projections 148. For example, the handle engagement projections 148 can extend into the recess 169 of the handle 106 when the handle 106 is situated on the shoulder 127, causing the handle 106 to at least partially nest within the base plate 103.

The aperture 151 of the base plate 103 is thus adapted to receive the handle projection 166 and provide a path of travel for the handle projection 166 during rotation of the handle 106. The handle projection 166 can assume a multitude of shapes and geometries. However, in some embodiments, the handle projection 166 can include a first tier 172a and a second tier 172b (collectively “tiers 172”), where the tiers 172 can be generally annular to facilitate rotation of the handle 106. In some embodiments, the tiers 172 are integral with one another.

Moreover, the second tier 172b can have a diameter less than the first tier 172a, providing annular tiers. In some embodiments, the second tier 172b includes a linear projection 175 extending laterally therefrom. The linear projection 175 can thus fan out from the second tier 172b and can be positioned in a corresponding slot 178 in the shoulder 127 of the base plate 103. Referring back to FIG. 7, the slot 178 can include a region having no ridge 154. As such, the ridge 154 can act as an interference stop, preventing over-rotation or under-rotation of the handle 106 relative to the base plate 103. The dimensions of the slot 178 thus define a range of rotation of the handle 106 relative to the base plate 103. A through-hole 180 can be provided at the bottom of the aperture 151 to receive the pin 133 in some embodiments.

As can be seen in FIG. 11, the handle 106 can include a non-uniform lower surface 163. The lower surface 163 of the handle 106, at the second end 130b, can include a coupling projection 181. The coupling projection 181 can extend downwards from a planar surface of the handle 106 and can be a contoured projection adapted to match a corresponding geometry of the base plate 103. The coupling projection 181 as contoured can include a hook 184.

The hook 184, for example, can protrude inwards towards the dividers 115, for example. As such, the second end wall 109b of the base plate 103 can include a sidewall projection 187 configured to align with the hook 184 and fix the second end 130b of the handle 106 with the second end wall 109b of the base plate 103. The sidewall projection 187 can project from an exterior side of the second end wall 109b, and the hook 184 can coupled to a bottom surface of the sidewall projection 187, for example. It is understood, however, that other potential couplings can detachably secure the second end 130b of the handle 106 to the base plate 103.

A lower view of the first end 130a of the handle 106 of the cable clip 100 is shown in FIG. 12B, and an upper view of the shoulder 127 of the base plate 103 is shown in FIG. 12C. Referring to FIGS. 12B and 12C collectively, a distal end of the handle 106 (e.g., an end positioned on or otherwise coupled to the shoulder 127 of the base plate 103) includes a recess 169 positioned proximate the tiers 172. The recess 169 is adapted to receive the handle engagement projections 148a, 148b of the base plate 103. In some embodiments, a first recess 169a is positioned on a first side of the tiers 172 and a second recess 169b is positioned on second side of the tiers 172. To this end, the first recess 169a can receive the first handle engagement projection 148a, and the second recess 169b can receive the second handle engagement projection 148b.

As shown in FIG. 12B, the first recess 169a can include an ascending ramp or, in other words, can have a slope ascending from the top of FIG. 12B to the bottom of FIG. 12B. As shown in FIG. 12C, the second recess 160b can include a descending ramp or, in other words, can have a slope descending from the top of FIG. 12B to the bottom of FIG. 12B. To engage with the ascending and descending ramps of the recesses 169a, 169b, as shown in FIG. 12C, the first handle engagement projection 148a can include a descending ramp or, in other words, can have a slope descending from the top of FIG. 12C to the bottom of FIG. 12C.

The second handle engagement projection 148b can include an ascending ramp or, in other words, can have a slope ascending from the top of FIG. 12C to the bottom of FIG. 12C. Thus, the first recess 169a can have a corresponding geometry relative to the first handle engagement projection 148a, and the second recess 169b can have a corresponding geometry relative to the second handle engagement projection 148a. The rotation of the handle 106 causes the handle 106 to ascend up the ramps or down the ramps based on the rotation of the handle 106 being in a first direction or a second direction, as can be appreciated. The linear projection 175 can thus fan out from the second tier 172b, and can be positioned in a corresponding slot 178 in the shoulder 127 of the base plate 103.

The slot 178 in the base plate 103 can include a region having no ridge 154. The linear projection 175 of the handle 106 can be positioned in the slot 178 and, as such, the ridge 154 can act as an interference stop, preventing over-rotation or under-rotation of the handle 106 relative to the base plate 103. The dimensions of the slot 178 thus define a travel path and a range of rotation of the handle 106 relative to the base plate 103.

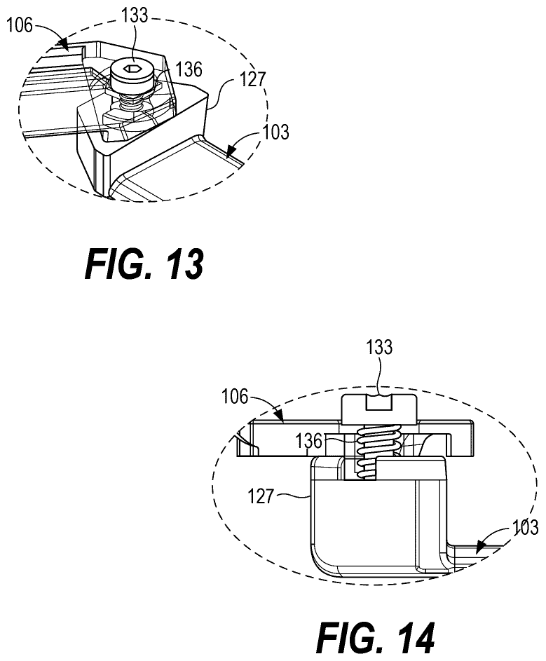

FIGS. 13 and 14 show enlarged perspective views illustrating rotation of the handle 106 of the cable clip 100 relative to the base plate 103. In FIG. 13, the handle 106 is shown in a partially rotated position relative to the base plate 103. The pin 133 extends through the handle 106 and into the shoulder 127 of the base plate 103, serving as the axis of rotation. The spring 136 or other biasing element can be positioned around the pin 133, providing a biasing force between the handle 106 and the base plate 103.

FIG. 14 presents a side view of the rotational mechanism. The pin 133 passes through the handle projection 166 of the handle 106 and into the aperture 151 of the base plate 103. The spring 136 surrounds the pin 133 and is compressed between the handle 106 and the shoulder 127 of the base plate 103. This arrangement allows for controlled rotation of the handle 106 while maintaining a biasing force.

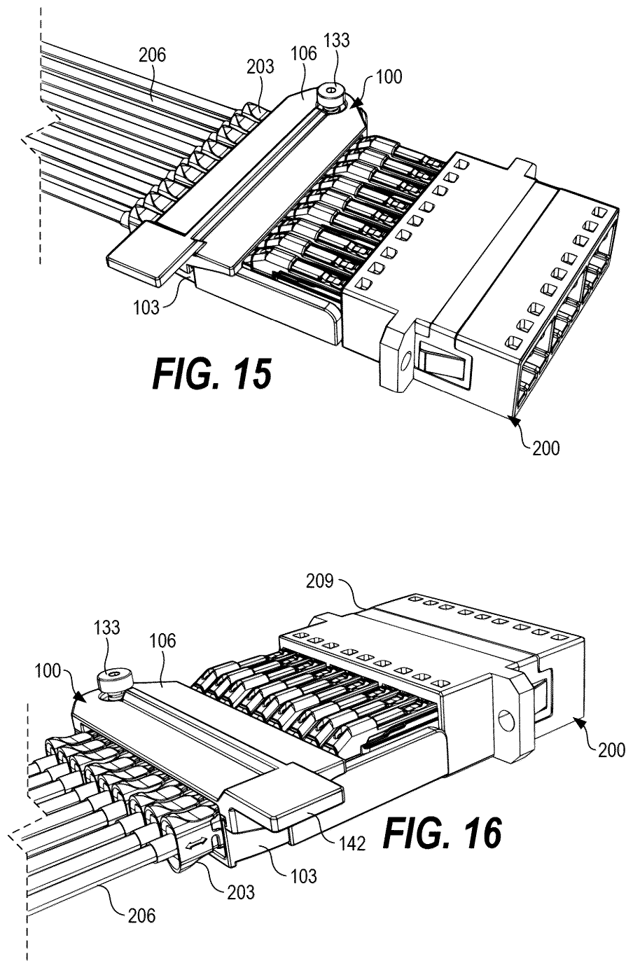

FIGS. 15 and 16 show perspective views of the cable clip 100 shown relative to a connector 200. The connector 200 includes a cable boot 203 and a cable 206, among other components. As such, FIGS. 15 and 16 show the cable clip 100 in a closed state storing cable boots 203 therein. In FIG. 15, the handle 106 is positioned over the base plate 103, securing multiple cable boots 203 within the cable storage areas 121. The cables 206 can extend from the cable boots 203 and out of the cable clip 100. A connector 200 can be a free-end connector that can be coupled to an electrical device or another connector. FIG. 16, on the other hand, provides a different angle of the closed cable clip 100. The handle 106 is fully engaged with the base plate 103, with the release tab 142 visible at one end. This configuration ensures that the cable boots 203 and their associated cables 206 are securely held in place within the cable clip 100.

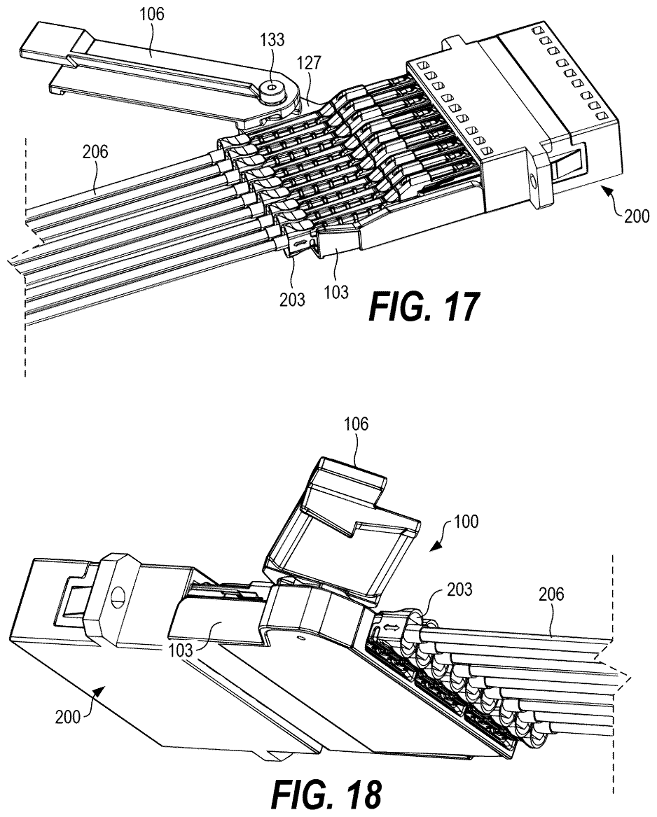

FIGS. 17 and 18 show perspective views of the cable clip 100 in an open state storing cable boots 203 therein. In FIG. 17, the handle 106 is rotated away from the base plate 103, exposing the cable storage areas 121 and the cable boots 203 stored therein. Multiple cable boots 203 are visible within these storage areas, with their respective cables 206 extending outward. The pin 133 facilitates the rotational movement of the handle 106 relative to the base plate 103.

FIG. 18 presents a different angle of the open cable clip 100. This view clearly shows how the cable boots 203 are arranged within the base plate 103, and how the handle 106 can be rotated to provide easy access for inserting or removing cables.

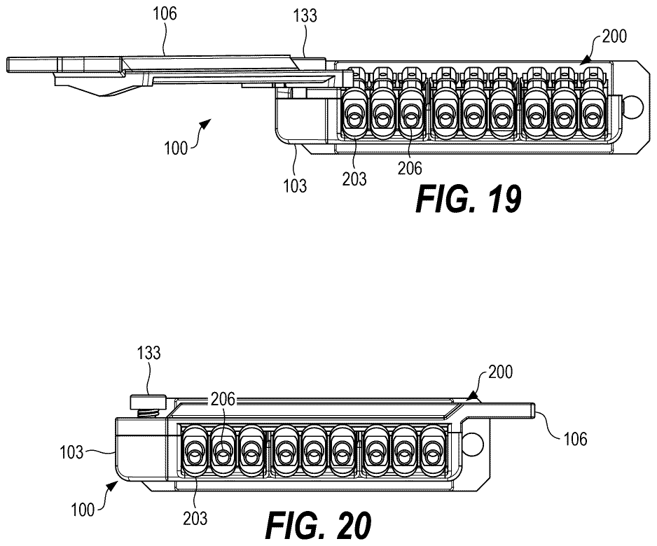

FIG. 19 shows a rear view of the cable clip 100 in the open state storing cable boots 203 therein. From this perspective, the arrangement of multiple cable boots 203 within the base plate 103 is clearly visible. The handle 106 is rotated upward, and the pin 133 that serves as the pivot point can be seen connecting the handle 106 to the base plate 103.

FIG. 20 shows a rear view of the cable clip 100 in the closed state storing cable boots 203 therein. In this configuration, the handle 106 is lowered onto the base plate 103, securing the cable boots 203 in place. The cables 206 can be seen extending from the cable boots 203, and a connector 200 may be visible at one end of the assembly.

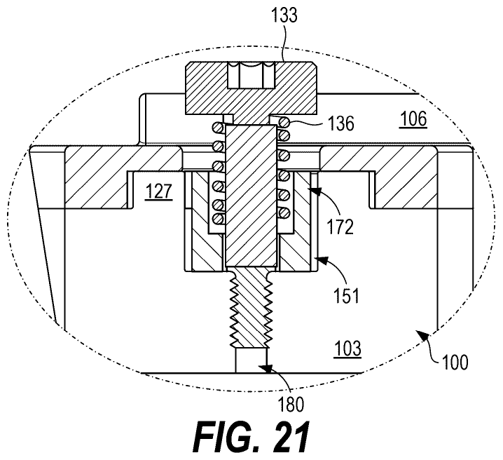

FIG. 21 shows a cross-section view of the spring-loaded pin 133 of the cable clip 100. The pin 133 extends through the handle projection 172 of the handle 106 and into the aperture 151 of the base plate 103. The spring 136 is positioned around the pin 133, between the handle 106 and the shoulder 127 of the base plate 103. A through-hole 180 in the base plate 103 may accommodate the lower portion of the pin 133. This arrangement allows for the spring-loaded rotational movement of the handle 106 relative to the base plate 103, providing a secure yet flexible mechanism for opening and closing the cable clip 100.

In some embodiments, the pin 133 can include a shoulder bolt, as shown in FIG. 21, providing a secure and precise rotational axis for the handle 106. However, the pin 133 is not limited to this configuration. In some aspects, the pin 133 can include a press fit pin, which can be inserted into the handle projection 172 and the aperture 151 with a tight interference fit, eliminating the need for additional fasteners.

In other implementations, the pin 133 can include a riveted pin, where the end of the pin is deformed after insertion to create a permanent connection. This configuration can provide a durable and tamper-resistant joint between the handle 106 and the base plate 103. In some cases, the pin 133 can be a threaded fastener, such as a machine screw or a threaded rod with nuts, allowing for easy disassembly if needed.

The pin 133 may also be implemented as a molded-in feature of either the handle 106 or the base plate 103. For instance, the handle projection 166 can include an integrally molded pin that extends into the aperture 151 of the base plate 103. Alternatively, the base plate 103 may have a molded pin that protrudes from the shoulder 127 and engages with a corresponding hole in the handle 106. In some embodiments, the pin 133 may be a quick-release pin, featuring a spring-loaded ball or other mechanism that allows for rapid insertion and removal. This configuration may facilitate easy disassembly of the cable clip 100 for maintenance or reconfiguration purposes.

In some embodiments, the pin 133 may be permanently fixed into the base plate 103, while the handle 106 can have some clearance with the pin 133, allowing for rotation and/or vertical movement. This configuration can provide stability to the base components while enabling the necessary flexibility in the rotation or other movement of the handle 106. The spring 136 can bias the handle 106 into a clamped position relative to the base plate 103. When the handle 106 is rotated or lifted (e.g., via the release tab 142), the spring 136 can compress, storing potential energy. Upon release, this stored energy can help return the handle 106 to its original, clamped position, ensuring secure closure of the cable clip 100 and maintaining pressure on the cable boots 203 or other cable components stored within.

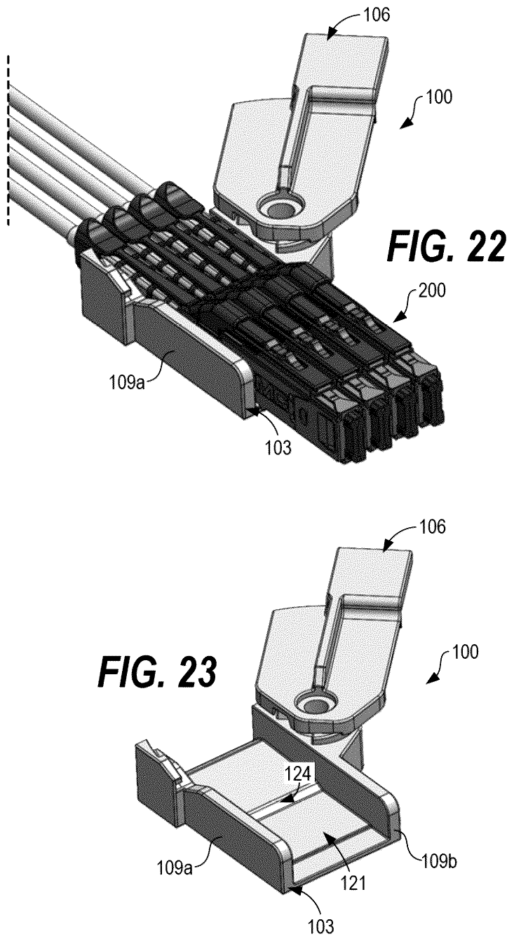

Turning now to FIGS. 22 and 23, front perspective views of another embodiment of the cable clip 100 is shown according to various embodiments. While various embodiments described herein include one or more dividers 115 that define the cable storage areas 121, in some embodiments, the dividers 115 are not provided in the base plate 103. For instance, the first end wall 109a and the second end wall 109b can collectively define a single cable storage area 121. This may be beneficial in cases in which there is an arrangement of four or more connectors 200 aligned in a single row. The cable boots (or other cable portions) can be closely aligned with respect to one another, as shown in FIG. 22, such that a divider 115 is not needed.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A cable clip for organizing cables, comprising:
a base plate, the base plate comprising at least one divider defining a plurality of cable storage areas, wherein the base plate further comprises a handle support portion having a shoulder, a handle engagement projection extending upwards from the shoulder, and an aperture positioned within the handle engagement projection; and
a handle rotatably coupled to the base plate, the handle comprising a bottom surface having a handle projection configured to extend into the aperture and an annular travel path defined in the bottom surface adapted to receive the handle engagement projection and provide a path of travel for the handle engagement projection during rotation of the handle.

2. The cable clip according to claim 1, wherein:
the plurality of cable storage areas are sized and positioned to receive a plurality of cable boots of a plurality of cables; and
each of the plurality of cable storage areas comprises at least one surface contoured to conform to a geometry of the plurality of cable boots.

3. The cable clip according to claim 2, further comprising a spring-loaded pin that biases the handle relative to the base plate, the spring-loaded pin extending through the handle projection and into the aperture of the base plate.

4. The cable clip according to claim 3, wherein:
the base plate has a first end and a second end, the shoulder being positioned on the first end; and
the handle has a first end and a second end, the first end of the handle being rotatably coupled to the shoulder of the base plate via the spring-loaded pin.

5. The cable clip according to claim 1, wherein the base plate comprises a first end wall and a second end wall, the at least one divider being positioned between the first end wall and the second end wall.

6. The cable clip according to claim 1, wherein the base plate comprises a front lip positioned between the first end wall and the second end wall, the front lip has a degree of incline, and the at least one divider extends to the front lip.

7. The cable clip according to claim 5, wherein:
the handle further comprises a contoured projection on a lower surface of the second end of the handle, the contoured projection comprising a hook; and
the second end wall of the base plate comprises a projection configured to align with the hook and fix the second end of the handle with the second end wall of the base plate.

8. The cable clip according to claim 7, wherein the handle further comprises a release tab extending from the second end of the handle, wherein an upward force imposed on the release tab or the second end of the handle disengages the second end of the handle from the second end of the base plate.

9. The cable clip according to claim 7, wherein the annular travel path is recessed into a bottom surface of the handle.

10. A pin-hinge clip for organizing cables, comprising:
a base plate, the base plate comprising a first end wall and a second end wall that collectively define a cable storage area; and
a handle rotatably coupled to the base plate about a spring-loaded pin that biases the handle relative to the base plate.

11. The pin-hinge clip according to claim 10, wherein:
the base plate further comprises a plurality of dividers extending upwards from a bottom surface of the base plate that define a plurality of cable storage areas, the cable storage area being one of the plurality of cable storage areas;
the plurality of cable storage areas are sized and positioned to receive a plurality of cable portions of a plurality of cables; and
the plurality of cable portions are a plurality of cable boots, and each of the plurality of cable storage areas comprises at least one surface contoured to conform to a geometry of the plurality of cable boots.

12. The pin-hinge clip according to claim 10, wherein:
the base plate comprises a handle support portion having a shoulder, at least one handle engagement projection extending upwards from the shoulder, and an aperture positioned within the at least one handle engagement projection; and
the handle comprises a bottom surface having a handle projection configured to extend into the aperture and a recess defined therein adapted to receive the at least one handle engagement projection, the recess defining an annular path of travel for the at least one handle engagement projection during a rotation of the handle.

13. The pin-hinge clip according to claim 12, wherein the spring-loaded pin extends through the handle projection and into the aperture of the base plate.

14. The pin-hinge clip according to claim 11, wherein the plurality of dividers are positioned between the first end wall and the second end wall.

15. The pin-hinge clip according to claim 14, wherein the base plate comprises a front lip positioned between the first end wall and the second end wall, and the plurality of dividers extend to the front lip.

16. The pin-hinge clip according to claim 15, wherein:
the base plate has a first end and a second end, the shoulder being positioned on the first end; and
the handle has a first end and a second end, the first end of the handle being rotatably coupled to the shoulder of the base plate.

17. The pin-hinge clip according to claim 16, wherein the handle projection comprises a first tier and a second tier integral with one another, the second tier having a diameter less than the first tier, the second tier of the projection comprising a linear projection extending therefrom configured to be positioned in a corresponding slot in the shoulder of the base plate.

18. The pin-hinge clip according to claim 17, wherein the spring-loaded pin extends through an aperture within the projection, and into a recess of the shoulder of the base plate.

19. The pin-hinge clip according to claim 16, wherein:
the handle further comprises a contoured projection on a lower surface of the second end of the handle, the contoured projection comprising a hook; and
the second end of the base plate comprises a projection configured to align with the hook and fix the second end of the handle with the second end of the base plate.

20. The pin-hinge clip according to claim 19, wherein the handle further comprises a release tab extending from the second end of the handle, wherein an upward force imposed on the release tab or the second end of the handle disengages the second end of the handle from the second end of the base plate.
